(19) United States
(12) Patent Application Publication
(10) Pub. No.: US 2013/0144026 A1
(43) Pub. Date: Jun. 6, 2013

(54) Method for Making a Thermo-Stable and Transparent Resin

(71) Applicants: Wen-Chiung Su, Taoyuan County (TW); Chi-Fa Hsieh, Taoyuan County (TW); Yeng-Fong Shih, Taoyuan County (TW)

(72) Inventors: Wen-Chiung Su, Taoyuan County (TW); Chi-Fa Hsieh, Taoyuan County (TW); Yeng-Fong Shih, Taoyuan County (TW)

(73) Assignee: Chung-Shan Institute of Science and Technology, Armaments, Bureau, Ministry of National Defense, Taoyuan County (TW)

(21) Appl. No.: 13/415,983

(22) Filed: Mar. 9, 2012

(30) Foreign Application Priority Data
Dec. 1, 2011 (TW) 100144248

(51) Int. Cl. C08G 79/08

(52) U.S. Cl. 528/43

(57) ABSTRACT

Disclosed is a method form making a thermo-stable and transparent resin. In the method, at first, polyborosiloxane is syhthesized by hydrolyzing and condensing a boron-containing compound, used as a precursor, and a silane compound. Then, epoxy group-containing polyborosiloxane is synthesized by grafting an epoxy group to the polyborosiloxane. Finally, an epoxy/PGB composite is synthesized by reacting the epoxy group-containing polyborosiloxane with epoxy for consolidation, thus providing a homogenous, stable, net-shaped composite.

### BACKGROUND OF INVENTION

1. Field of Invention

The present invention relates to a method for making a thermo-stable and transparent resin and, more particularly, to a method for making an isolating, transparent, thermo-stable, compatible and adhesive composite including epoxy and polyborosiloxane (PGB).

2. Related Prior Art

As the economy and technology develop, the powers of lighting elements increase. Therefore, a lot of attention is paid to the thermo-stability as well as the transmittance.

Epoxy is used in electronic elements because it can easily be molded and processed, and exhibits excellent mechanical properties and adhesiveness and little shrinkage. Epoxy however exhibits poor thermo-stability and suffers aging after it is irradiated by light.

Silicone is used in electronic elements for exhibiting excellent thermo-stability and photo-stability.

Ordinary resins exhibit poor thermo-stabilities and suffer aging after they are irradiated by light, and hence are added with inorganic materials such as silicon dioxide, clay and aluminum trioxide to improve the thermo-stability and heat-conductivity. These inorganic materials however often suffer phase separation that can be overcome by surface treatment. Composites however suffer high densities and poor transmittances.

There are attempts to use epoxy silane, a combination of epoxy with silicone, is used for exhibiting the advantages of silicone and epoxy. Epoxy silane is however expensive.

There are attempts to use thermo-stable and transparent polyborosiloxanes, combinations of silicon atoms with boron atoms, are used. Polyborosiloxanes however suffer poor adhesiveness and processability.

The present invention is therefore intended to obviate or at least alleviate the problems encountered in prior art.

### SUMMARY OF INVENTION

It is an objective of the present invention to provide a method for making an isolating, transparent, thermo-stable, compatible and adhesive composite by combining insulating and adhesive epoxy with a thermo-stable polyborosiloxane (PGB).

It is another objective of the present invention to provide an isolating, adhesive and thermo-stable composite that involves a simple process, exhibits a low density, and can be used in an electronic element.

To achieve the foregoing objectives, the method includes the steps of syhthesizing polyborosiloxane, synthesizing epoxy group-containing polyborosiloxane, and synthesizing an epoxy/PGB composite. The synthesis of the polyborosiloxane is executed by causing a boron-containing compound, used as a precursor, to react with a silane compound, for hydrolysis and condensation. The synthesis of the epoxy group-containing polyborosiloxane is executed by grafting an epoxy group to the polyborosiloxane. The synthesis of the poxy/PGB composite is executed by reacting the epoxy group-containing polyborosiloxane with epoxy for consolidation, thus providing a homogenous, stable, net-shaped composite.

In an aspect, the silane compound includes two or three functional groups. The silane compound may be diphenyldichlorosilane, diphenylsilanediol or phenyltrimethoxysilane.

In another aspect, the boron-containing compound may be boric acid, boron oxide, boron trichloride, boron tribromide or borate ester.

In another aspect, the step of synthesizing the epoxy group-containing polyborosiloxane includes the step of reacting the polyborosiloxane with a epoxy group-containing for modification and grafting. The epoxy group-containing silane coupling agent may be 3-glycidoxypropyltrimethoxysilane (“GPTMOS”).

In another aspect, the step of synthesizing the epoxy group-containing polyborosiloxane includes the step of reacting an epoxy group-containing silane coupling agent with boric acid for condensation to remove methyl. The epoxy group-containing silane coupling agent may be 3-glycidoxypropyltrimethoxysilane (“GPTMOS”).

In another aspect, the thermo-stability temperature of the thermo-stable transparent composite when it loses 5% of its weight is increased by at least 40% as the concentration of the epoxy group-containing polyborosiloxane is at least 10%.

In another aspect, the concentration of tar is increased by at least 10% as the concentration of the epoxy group-containing polyborosiloxane is increased by at least 10% in comparison with pure epoxy.

In another aspect, the transmittance of the thermo-stable transparent composite is least 91% as the concentration of the epoxy group-containing polyborosiloxane is at least 30%.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 shows a processing for synthesizing polyborosiloxane in a method for making a thermo-stable and transparent composite according to the preferred embodiment of the present invention;

FIG. 2 is a chemical formula for grafting an epoxy group-containing silane coupling agent to the polyborosiloxane shown in FIG. 1;

FIG. 3 is another chemical formula for grafting an epoxy group-containing silane coupling agent to the polyborosiloxane shown in FIG. 1;

FIG. 4 is a chemical formula for consolidating epoxy and the epoxy group-containing polyborosiloxane shown in FIG. 2;

FIG. 5 is a chemical formula for reacting diphenyldichlorosilane with boric acid in the method according to the preferred embodiment of the present invention;

FIG. 6 shows a chemical formula for reacting phenyltrimethoxysilane with boric acid in the method according to the preferred embodiment of the present invention; and

FIG. 7 is a chart of the result of TGA analysis of the epoxy/PGB composite made in the method according to the preferred embodiment of the present invention.

### DETAILED DESCRIPTION OF PREFERRED EMBODIMENT

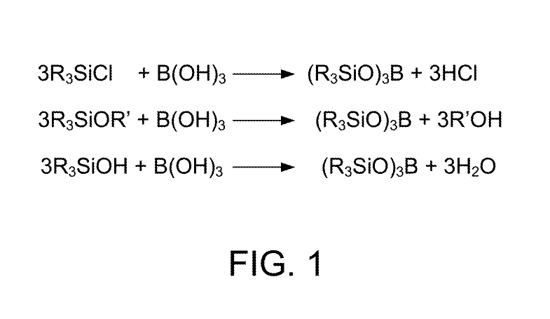

Referring to FIGS. 1 to 4, there is shown a method for making a thermo-stable and transparent resin according to the preferred embodiment of the present invention.

At first, polyborosiloxane is synthesized. To this end, a boron-containing compound, used as a precursor, and a silane compound are subjected to hydrolysis and condensation, thus providing polyborosiloxane. The boron-containing compound may be boric acid, boron trioxide, boron trichloride, boron tribromide or borate ester. The silane compound may include two or three functional groups, and may be diphenyldichlorosilane, diphenylsilanediol or phenyltrimethoxysilane.

Referring to FIG. 1, the silane chain is introduced into the molecular structure to provide a homogenous, molecule-class compound. To this end, silicon atoms are combined with boron atoms so that the resultant compound exhibits excellent thermo-stability. The boric acid and the silane compound react with each other.

Secondly, epoxy group-containing polyborosiloxane is synthesized. To this end, the polyborosiloxane is connected to epoxy group, thus providing epoxy group-containing polyborosiloxane (“PGB”).

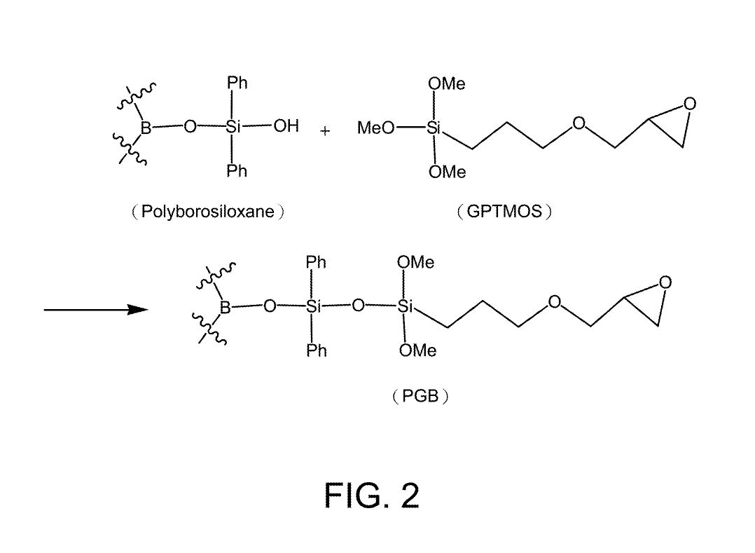

Referring to FIG. 2, to synthesize the epoxy group-containing polyborosiloxane, an epoxy group-containing silane coupling agent may be grafted to the polyborosiloxane. The polyborosiloxane inherently exhibits excellent thermo-stability for including the silicon atoms and the boron atoms. The epoxy group-containing silane coupling agent is grafted to the polyborosiloxane to provide the epoxy group-containing polyborosiloxane. Thus, the interface adhesiveness between the polyborosiloxane and the epoxy is increased, and so is the compatibility. The epoxy group-containing silane coupling agent may be 3-glycidoxypropyltrimethoxysilane (“GPTMOS”).

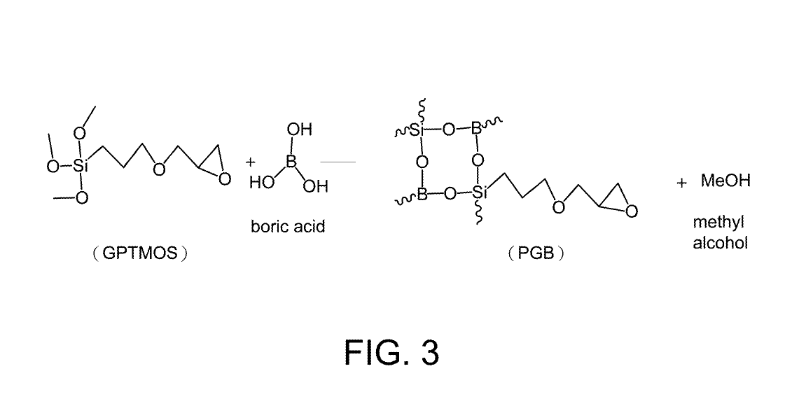

Referring to FIG. 3, to synthesize the epoxy group-containing polyborosiloxane, an epoxy group-containing silane coupling agent (such as GPTMOS) may alternatively react with boric acid for condensation to remove methyl.

Thirdly, an epoxy/PGB composite is made. To this end, the epoxy group-containing polyborosiloxane is mixed with epoxy for consolidation, thus providing a homogenous, stable, net-shaped composite.

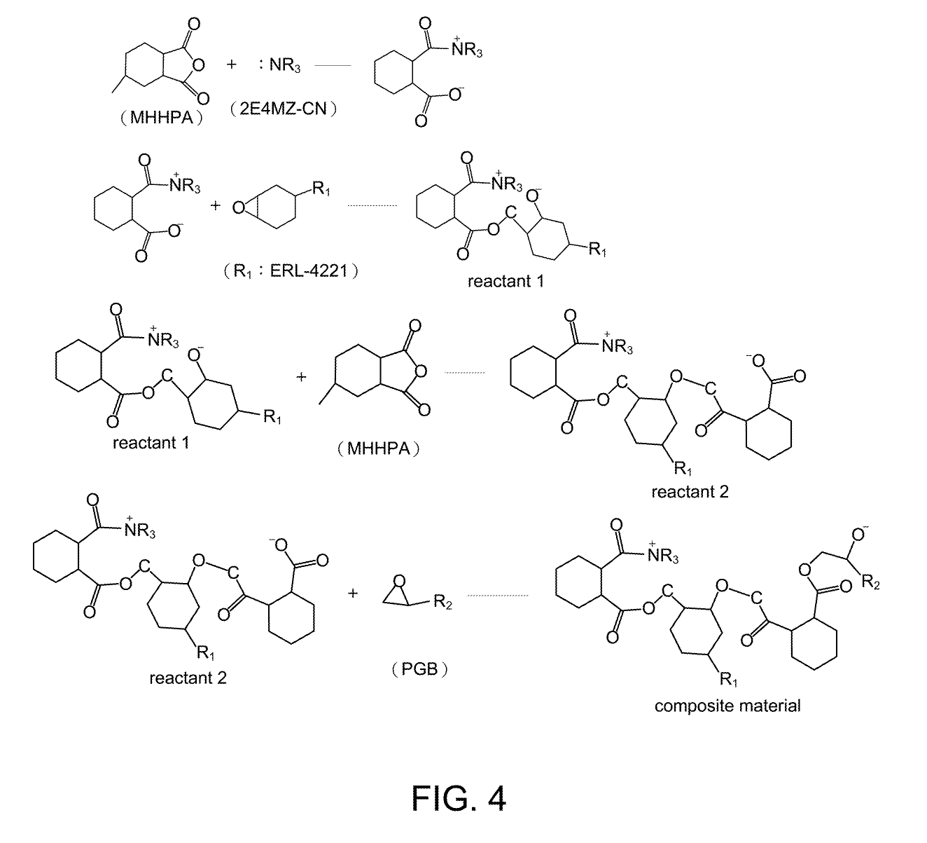

Referring to FIG. 4, the epoxy group-containing polyborosiloxane and epoxy are subjected to consolidation. By the consolidation, there is excellent compatibility between the polyborosiloxane and the epoxy.

EPGB-1—Diphenylborosiloxane Oligomer or Phenylborosiloxane Oligomer

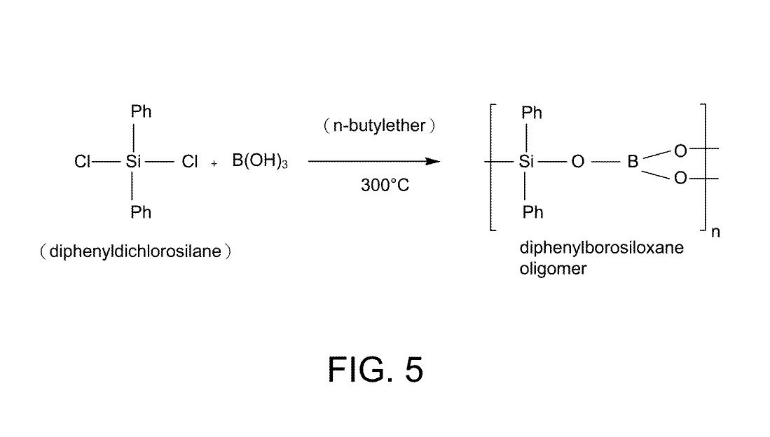

Referring to FIG. 5, n-butylether is used as a solvent. At, 200° C. to 300° C., nitrogen is introduced into the solvent. Diphenyldichlorosilane reacts with boric acid at a molecular ratio of 2:1 to provide diphenylborosiloxane oligomer. The yield rate is about 90%. The molecular weight of the diphenylborosiloxane oligomer is about 2500.

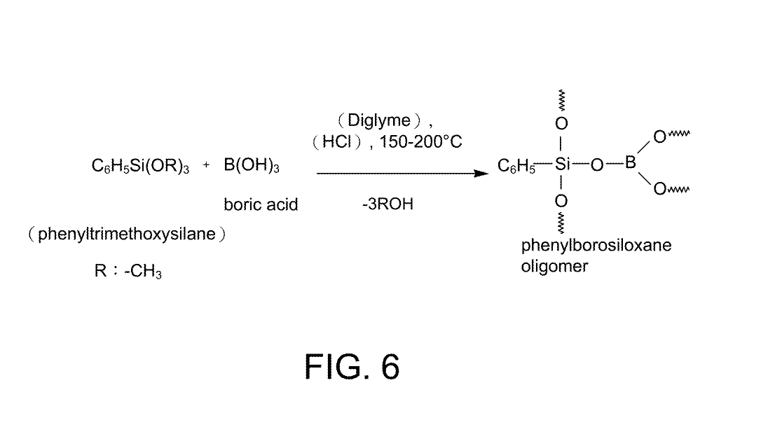

Referring to FIG. 6, diglyme may alternatively be used as the solvent. At 150° C. to 200° C., in the solvent, phenyltrimethoxysilane reacts with boric acid at a molecular ratio of 2:1 to provide phenylborosiloxane oligomer. The yield rate is 80%. The molecular weight of the phenylborosiloxane oligomer is about 3000.

EPGB-2—Epoxy Group-Containing Polyborosiloxane

Referring to FIG. 2, the epoxy group-containing silane coupling agent (“GPTMOS”) is grafted to the diphenylborosiloxane oligomer (including the polyborosiloxane) to provide the epoxy group-containing polyborosiloxane to increase the compatibility between the polyborosiloxane and the epoxy in the composite.

Referring to FIG. 3, the epoxy group-containing silane coupling agent (“GPTMOS”) reacts with the boric acid at a molecular ratio of 2:1. Without any solvent, at 50° C. to 80° C., by condensation and removal of the methyl by suction for 30 minutes, the epoxy group-containing polyborosiloxane is made.

The yield rate is about 90%. The molecular weight of the epoxy group-containing polyborosiloxane is about 560.

EPGB-3—Consolidation

In the consolidation of the epoxy group-containing polyborosiloxane and the epoxy, alicyclic epoxy such as 3,4 epoxy cyclohexyl carboxylate, (“ERL-4221”) is mixed with a curing agent such as methyl hexahydro phthalic anhydride (“MHHPA”) at a molecular ratio of 1:0.8, and then added with a catalyst such as 1-(2-cyanoethyl)-2-ethyl-4-methylimidazole (“2E4MZ-CN”). The weight of the catalyst is about 1% of the weight of the epoxy 1%. After they are mixed evenly, they are subjected to curing at 140° C. for 30 minutes.

TABLE 1

| | EPGB-1 | EPGB-2 | EPGB-3 | |
|---|---|---|---|---|
| ERL-4221 | 30 | 30 | 0 | Epoxy |
| MHHPA | 20 | 20 | 20 | Curing agent |
| 2E4MZ-CN | 0.3 | 0.3 | 0.3 | Catalyst |
| RGB | 3 | 6 | 9 | Composite additive |

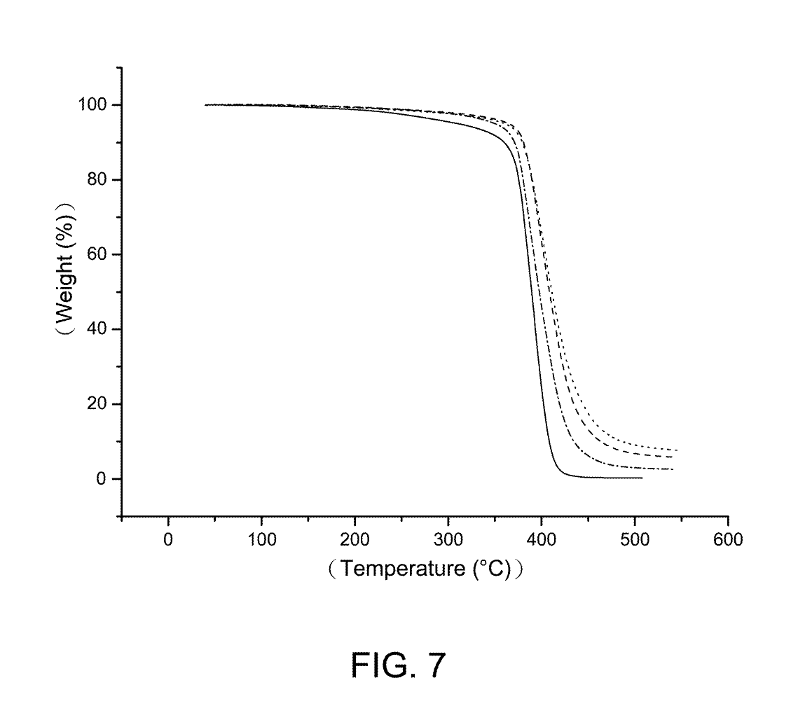

Referring to FIG. 7, TGA tests are run on the pure epoxy and its composites EPGB-1, EPGB-2 and EPGB-3. The solid line represents the pure epoxy. The chain line represents composite EPGB-1. The phantom line represents composite EPGB-2. The dotted line represents composite EPGB-3. The thermo-stability temperatures (T_{d5}) at which they lose 5% of their weights are 310° C., 350° C., 365° C. and 361° C., respectively. With more than 10% of PGB, the thermo-stability temperatures rise for at least 40° C. The concentration of tar at 500° C. increases from 0.26% (epoxy) to 3.0%, 6.8% and 9.1%, respectively. That is, the concentration of tar at 500° C. increases for at least 10%. It is proven that the addition of PGB into epoxy considerably increases the thermo-stability.

A UV-VIS spectrophotometer is used to the transparency value of the air and the transparency value of the specimens. Then, the transparency value of the specimens are divided by the transparency value of the air to provide the transmittances of the specimens EPGB-1, EPGB-2 and EPGB-3. The transmittances of the specimens are shown in Table 2. It is proven that with more than 30% of PGB, the transmittance is not considerably changed. The transmittances of the composites are still higher than 91%.

TABLE 2

| Pure epoxy | EPGB-1 | EPGB-2 | EPGB-3 |
|---|---|---|---|
| 91.3% | 91.2% | 91.4% | 91.7% |

According to the present invention, a boron-containing compound, used as a precursor, and a silane compound are subjected to hydrolysis and condensation to provide an epoxy group-containing polyborosiloxane. By the thermo-stability of the boron and silicon functional groups and a curing technique, the epoxy group-containing polyborosiloxane and epoxy are made into a composite that exhibits excellent thermo-stability, transparence and mechanical properties and low shrinkage, and can easily be molded and processed. In comparison with a compound added with an additive, the composite with the thermo-stable material connected to a molecule by bonds according to the present invention involves a simple process and exhibits a low density. The composite of the present invention exhibits good thermo-stability in addition to the inherent advantages of epoxy, and hence is suitable for use in an illuminator.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method form making a thermo-stable and transparent resin including the steps of:
syhthesizing polyborosiloxane by causing a boron-containing compound, used as a precursor, to react with a silane compound for hydrolysis and condensation;
synthesizing epoxy group-containing polyborosiloxane by grafting an epoxy group to the polyborosiloxane; and
synthesizing an epoxy/PGB composite by reacting the epoxy group-containing polyborosiloxane with epoxy for consolidation, thus providing a homogenous, stable, net-shaped composite.

2. The method for making a thermo-stable transparent composite according to claim 1, wherein the silane compound includes two or three functional groups.

3. The method for making a thermo-stable transparent composite according to claim 2, wherein the silane compound is selected from the group consisting of diphenyldichlorosilane, diphenylsilanediol and phenyltrimethoxysilane.

4. The method for making a thermo-stable transparent composite according to claim 1, wherein the boron-containing compound is selected from the group consisting of boric acid, boron oxide, boron trichloride, boron tribromide and borate ester.

5. The method for making a thermo-stable transparent composite according to claim 1, wherein the step of synthesizing the epoxy group-containing polyborosiloxane includes the step of reacting the polyborosiloxane with a epoxy group-containing for modification and grafting.

6. The method for making a thermo-stable transparent composite according to claim 5, wherein the epoxy group-containing silane coupling agent is 3-glycidoxypropyltrimethoxysilane (“GPTMOS”).

7. The method for making a thermo-stable transparent composite according to claim 1, wherein the step of synthesizing the epoxy group-containing polyborosiloxane includes the step of reacting an epoxy group-containing silane coupling agent with boric acid for condensation to remove methyl.

8. The method for making a thermo-stable transparent composite according to claim 7, wherein the epoxy group-containing silane coupling agent is 3-glycidoxypropyltrimethoxysilane (“GPTMOS”).

9. The method for making a thermo-stable transparent composite according to claim 1, wherein the thermo-stability temperature of the thermo-stable transparent composite when it loses 5% of its weight is increased by at least 40% as the concentration of the epoxy group-containing polyborosiloxane is at least 10%.

10. The method for making a thermo-stable transparent composite according to claim 1, wherein the concentration of tar is increased by at least 10% as the concentration of the epoxy group-containing polyborosiloxane is increased by at least 10% in comparison with pure epoxy.

11. The method for making a thermo-stable transparent composite according to claim 1, wherein the transmittance of the thermo-stable transparent composite is least 91% as the concentration of the epoxy group-containing polyborosiloxane is at least 30%.
